(19) United States
(12) Patent Application Publication
(10) Pub. No.: US 2012/0193205 A1
(43) Pub. Date: Aug. 2, 2012

(54) CARBON NANOTUBE BASED KEYBOARD

(75) Inventors: KAI-LI JIANG, Beijing (CN); SHOU-SHAN FAN, Beijing (CN); JIA-SHYONG CHENG, New Taipei (TW); LIANG LIU, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 13/196,030

(22) Filed: Aug. 2, 2011

(30) Foreign Application Priority Data
Jan. 28, 2011 (CN) 201110031061.0

(51) Int. Cl. H01H 13/76; B82Y 99/00

(52) U.S. Cl. 200/5 A; 977/742

(57) ABSTRACT

A keyboard includes a first substrate, a second substrate, a first electrode layer and a second electrode layer. The first substrate includes a first upper surface and a first lower surface opposite the first upper surface. The second substrate is positioned apart from the first substrate and includes a second upper surface and a second lower surface. The second upper surface faces the first lower surface. The first electrode layer is positioned on the first lower surface and comprises a plurality of first conductive layers disposed apart from each other and including at least one lead wire. The second electrode layer is positioned on the second upper surface and includes a second conductive layer including a carbon nanotube layer structure. A plurality of keys is positioned on the first upper surface or the second lower surface.

### RELATED APPLICATIONS

This application claims all benefits accruing under 35 U.S.C. §119 from China Patent Application No. 201110031061.0, filed on Jan. 28, 2011, in the China Intellectual Property Office, the disclosure of which is incorporated herein by reference.

### BACKGROUND

1. Technical Field

The disclosure relates to keyboards and, particularly, to a carbon nanotube-based keyboard.

2. Description of Related Art

Conventional keyboards are rigid structures made of rigid plastics, which makes the conventional keyboards hurt people. Further, the conventional keyboards has large scale, as such, they are not convenient for people to bring and unsuitable for tiny digital apparatus.

What is needed, therefore, is a keyboard that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic top view of an embodiment of a keyboard.

FIG. 2 is a schematic section view along line II-II of the keyboard in FIG. 1.

FIG. 3 is a schematic view of a first electrode layer used in the keyboard of FIG. 1.

FIG. 4 is a schematic view of a second electrode layer used in the keyboard of FIG. 1.

FIG. 5 shows a Scanning Electron Microscope image of an untwisted carbon nanotube wire.

FIG. 6 shows a Scanning Electron Microscope image of a twisted carbon nanotube wire.

FIG. 7 shows a Scanning Electron Microscope image a drawn carbon nanotube film.

FIG. 8 is a schematic view of a first electrode layer used in a keyboard of another embodiment.

FIG. 9 is a schematic view of a first electrode layer used in a keyboard of one embodiment.

FIG. 10 is a schematic view of a second electrode layer used in a keyboard of another embodiment.

FIG. 11 is a schematic view of a second electrode layer used in a keyboard of yet another embodiment.

FIG. 12 is a schematic view of a second electrode layer used in a keyboard of still another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

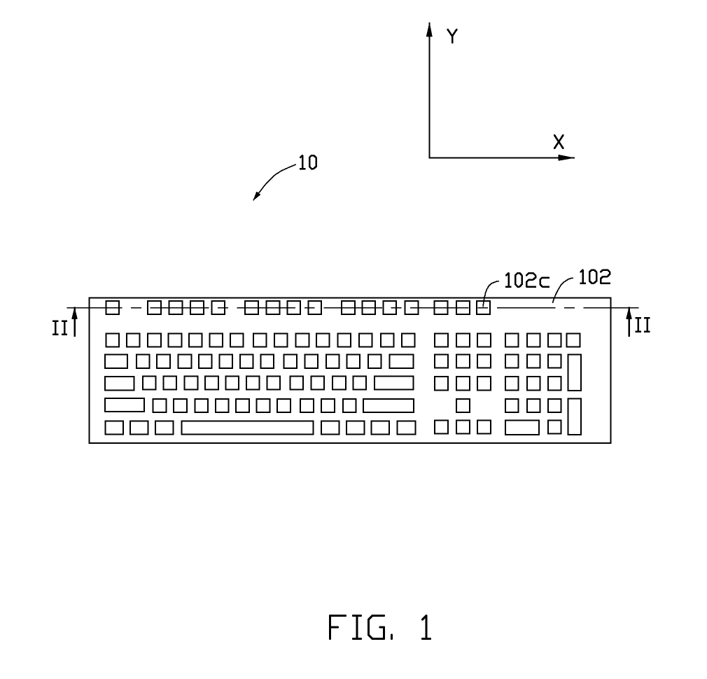

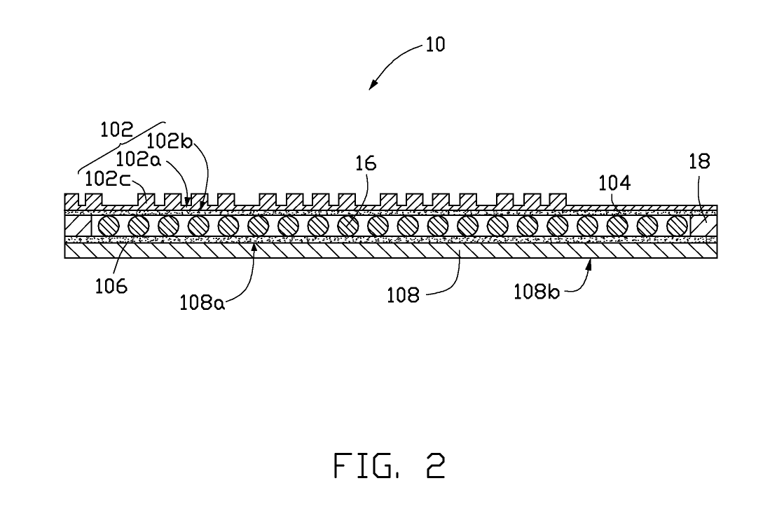

Referring to FIG. 1 and FIG. 2, one embodiment of a keyboard 10 includes a first substrate 102, a first electrode layer 104, a second electrode layer 106, a plurality of dot spacers 16, and a second substrate 108. The first substrate 102 and the second substrate 108 are located apart from each other. The first substrate 102 includes a first upper surface 102a and a first lower surface 102b opposite the first upper surface 102a. The first upper surface 102a is an operating surface for users. The second substrate 108 includes a second upper surface 108a and a second lower surface 108b. The second upper surface 108a faces the first lower surface 102b. The plurality of spacers 16 is located between the first lower surface 102b and the second upper surface 108a. The first electrode layer 104 is located on the first lower surface 102b. The first electrode layer 104 can be fixed on the first lower surface 102b via adhesive or mechanical method. The second electrode layer 106 is located on the second upper surface 108a. The second electrode layer 106 can be fixed on the first lower surface 102b via adhesive or mechanical method. The first electrode layer 104 faces the second electrode layer 106. The location of the first electrode layer 104 and the second electrode layer 106 can be changed with each other. That is to say, the first electrode layer 104 can be located on the second upper surface 108a and the second electrode layer 106 can be located on the first lower surface 102b.

A material of the first substrate 102 is flexible and insulative. The material of the first substrate 102 can be resin, rubber, plastics or combination thereof. The material of the first substrate can be polycarbonate (PC), polymethyl methacrylate acrylic (PMMA), polyethylene terephthalate (PET), polyethersulfones (PES), polyvinylchloride (PVC), benzocyclobutenes (BCB), polyesters, or acrylic resins. A number of keys 102c are located on the first upper surface 102a of the first substrate 102. Each of the number of keys 102c can have a different mark from the other keys 102c, such as letters. The keys 102c are arranged to form a plurality of rows, and each row includes at least one key 102c. Each row is oriented in an X direction as shown in FIG. 1. Each row can include a plurality of keys 102c, and the keys 102c in the same row can have the same width. The length of the keys 102c in the same row can be different from each other. Each of the keys 102c can have a rectangular shape having a width and a length in the X direction, or any other shape as desired. In one embodiment, the keys 102c are a plurality of protrusions on the first upper surface 102a. In one embodiment according to FIGS. 1 and 2, the first substrate 102 is made of a rubber material, and six lines of keys 102c are formed on the first upper surface 102a having the marks on the keys 102c similar to a conventional keyboard.

A material of the second substrate 108 can be the same as the first substrate 102. In one embodiment, the material of the second substrate 108 is fabric.

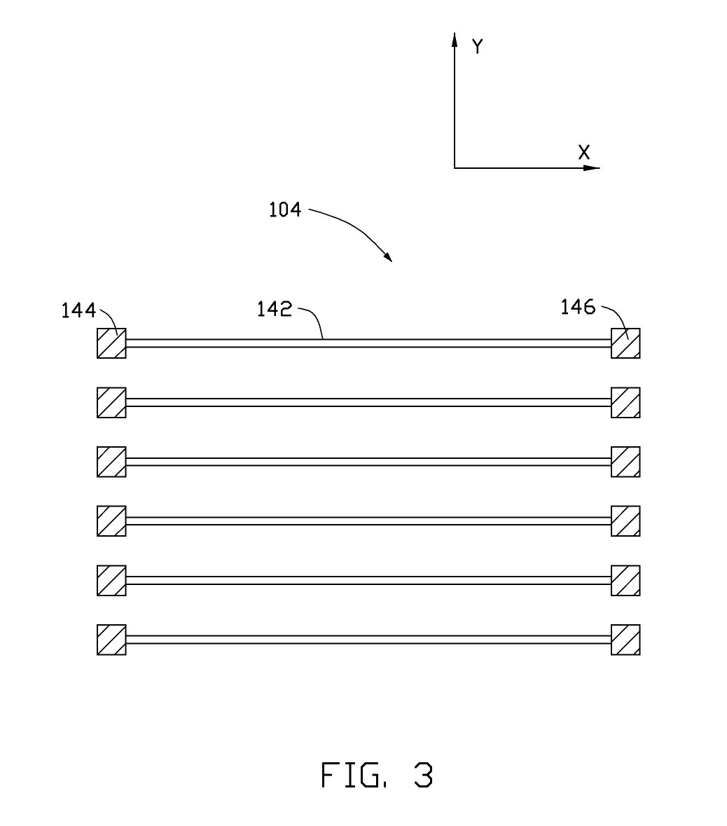

Referring also to FIG. 3, the first electrode layer 104 includes a plurality of first conductive layers 142, a plurality of first electrodes 144, and a plurality of second electrodes 146. The plurality of first electrodes 144 and the plurality of second electrodes 146 are electrically connected to the plurality of first conductive layers 142 and located separately on two opposite ends of the plurality of first conductive layers 142. Each first conductive layer 142 is electrically connected with one first electrode 144 and one second electrode 146. The plurality of first conductive layers 142 can be bar-shaped and located apart from each other. The first conductive layers 142 can be parallel with each other. In one embodiment, the first conductive layers 142 are primarily oriented along the X direction. The first electrodes 144 and the second electrodes 146 are substantially arranged along the Y direction. The X direction is substantially perpendicular with the Y direction. A distance between adjacent conductive layers 142 can be uniform or random. The distance can be determined by the keys 102c, and can be in a range from about 10 micrometers to about 1 centimeter. In the embodiment according to FIG. 3, the distance between adjacent first conductive layers 142 is uniform, and is about 2 millimeters. The width or length of the first conductive layers 142 can be uniform or different from each other. In the embodiment according to FIG. 3, the width of the first conductive layers 142 is about 1 centimeter, and the length of the first conductive layers 142 is about 30 centimeters.

One first conductive layer 142 located between one first electrode 144 and one second conductive layer 146 forms a conductive passage. Therefore, a plurality of conductive passages is formed between the first electrodes 144 and the second electrodes 146. The number of conductive passages is greater than the number of rows of the keys 102c, to ensure that location of each key 102c can be detected. A distance between adjacent first conductive layers 142 is equal to or less than a distance between the adjacent rows of the keys 102c. In one embodiment according to FIG. 3, the number of the first conductive layer 142 is six, and six conductive passages are formed. The first electrodes 144 are input electrodes and the second electrodes 146 are output electrodes. In other embodiment, the second electrodes 146 are input electrodes a the first electrodes 144 are output electrodes.

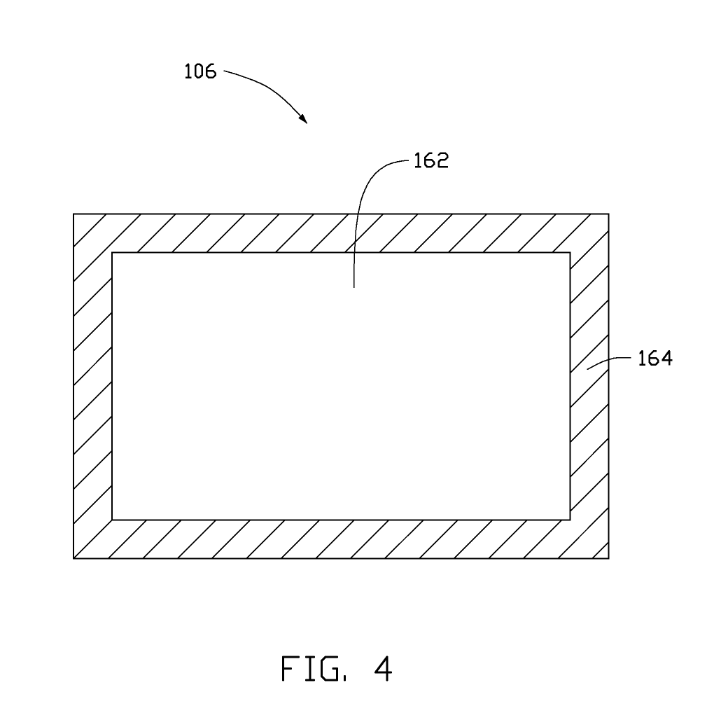

Referring to FIG. 4, the third electrode layer 106 includes a second conductive layer 162 and a third electrode 164. The third electrode 164 is electrically connected with the second conductive layer 162. The third electrode 164 surrounds and contacts the second conductive layer 162. In one embodiment illustrated in FIG. 4, the second electrode 164 is located on a surface of the second conductive layer 162 and symmetrically aligned with four sides of the second conductive layer 162.

An insulative layer 18 is further provided between the first and second substrates 102, 108 and surrounds the first electrode layer 104 or the second electrode layer 106. In one embodiment, the insulative layer 18 is in the form of a rectangular frame. The first electrode layer 104 faces, but is spaced from, the second electrode layer 106. The dot spacers 16 are located on the second conductive layer 142. A distance between the second electrode layer 106 and the first electrode layer 104 is typically in a range from about 1 cm to 2 cm. The insulative layer 18 and the dot spacers 16 are made of, for example, insulative resin or any other suitable insulative material. Electrical insulation between the first electrode layer 104 and the second electrode layer 106 is provided by the insulative layer 18 and the dot spacers 16. It is to be understood that the dot spacers 16 are optional, particularly if the size of the keyboard 10 is relatively small.

The first electrodes 144, the second electrodes 146 and the third electrodes 164 are made of conductive materials, such as metal, alloy, or indium tin oxide (ITO). The shape of the third electrode 164 can be linear, such as wire-shaped or bar-shaped. The shapes of the first electrodes 144 and the second electrodes 146 can be block-shaped. The cross-sectional shape of the first electrodes 144, the second electrodes 146, and the third electrodes 164 can be round, polygonal such as a square, trapezium, or triangle, or any other shape. The thickness of the first electrodes 144, the second electrodes 146 and the third electrodes 164 can be any size, depending on the design. In one embodiment, the first electrodes 144 and the second electrodes 146 are both silver spots made by a screen print method, and the third electrodes 164 are silver wire made by a screen print method.

Each first conductive layer 142 includes at least one lead wire. Each first conductive layer 142 includes a plurality of lead wires. The plurality of lead wires can be parallel with each other or crossed with each other. The lead wire can be a carbon nanotube wire structure. The carbon nanotube wire structure includes a plurality of carbon nanotubes joined end to end by van der Waals attractive force therebetween. The carbon nanotube wire structure can be a substantially pure structure of carbon nanotubes, with few impurities. The carbon nanotube wire structure can be a freestanding structure, that is, the carbon nanotube wire structure can be supported by itself without a substrate. For example, if at least one point of the carbon nanotube wire structure is held, the entire carbon nanotube wire structure can be lifted without being destroyed.

The carbon nanotubes in the carbon nanotube wire structure can be selected from single-walled, double-walled, and/or multi-walled carbon nanotubes. The carbon nanotube wire structure includes at least one carbon nanotube wire. When the carbon nanotube wire structure includes at least two carbon nanotube wires, the at least two carbon nanotube wires can be parallel with each other or twisted with each other.

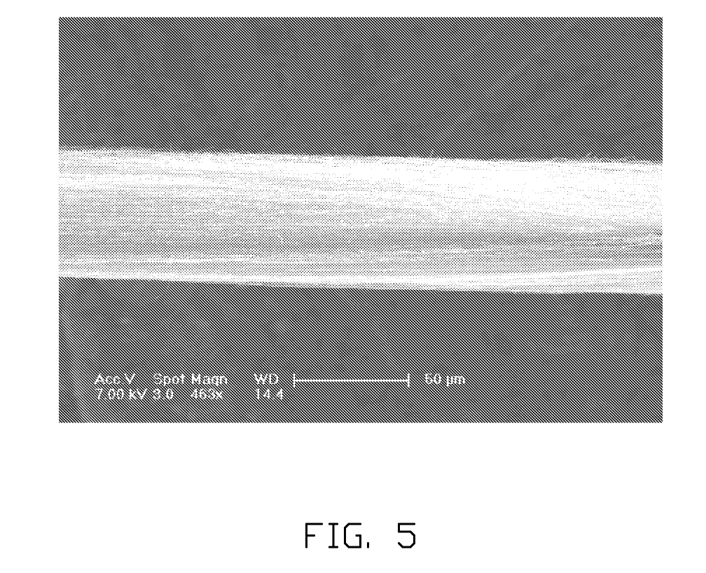

The carbon nanotube wire can be untwisted or twisted. Referring to FIG. 5, the untwisted carbon nanotube wire includes a plurality of carbon nanotubes substantially oriented along a same direction (i.e., a direction along the length direction of the untwisted carbon nanotube wire). The untwisted carbon nanotube wire can be a pure structure of carbon nanotubes. The untwisted carbon nanotube wire can be a freestanding structure. The carbon nanotubes are substantially parallel to the axis of the untwisted carbon nanotube wire. In one embodiment, the untwisted carbon nanotube wire includes a plurality of successive carbon nanotube segments joined end to end by van der Waals attractive force therebetween. Each carbon nanotube segment includes a plurality of carbon nanotubes substantially parallel to each other, and combined by van der Waals attractive force therebetween. The carbon nanotube segments can vary in width, thickness, uniformity and shape. Length of the untwisted carbon nanotube wire can be arbitrarily set as desired. A diameter of the untwisted carbon nanotube wire ranges from about 50 nm to about 100 μm.

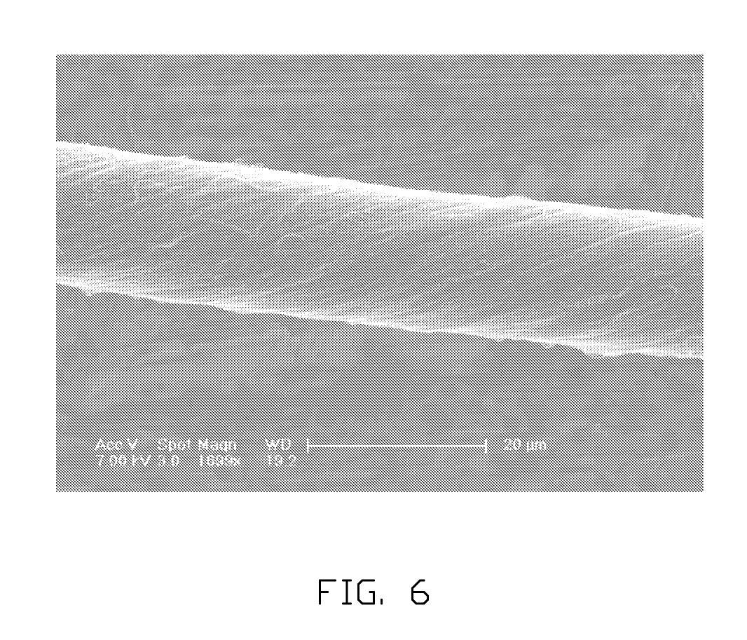

Referring to FIG. 6, the twisted carbon nanotube wire includes a plurality of carbon nanotubes helically oriented around an axial direction of the twisted carbon nanotube wire. The twisted carbon nanotube wire can be a pure structure of carbon nanotubes. The twisted carbon nanotube wire can be a freestanding structure. In one embodiment, the twisted carbon nanotube wire includes a plurality of successive carbon nanotube segments joined end to end by van der Waals attractive force therebetween. Each carbon nanotube segment includes a plurality of carbon nanotubes substantially parallel to each other, and combined by van der Waals attractive force therebetween. The length of the carbon nanotube wire can be set as desired. A diameter of the twisted carbon nanotube wire can be from about 50 nm to about 100 μm. Furthermore, the twisted carbon nanotube wire can be treated with a volatile organic solvent after being twisted. After being soaked by the organic solvent, the adjacent substantially parallel carbon nanotubes in the twisted carbon nanotube wire will bundle together, due to the surface tension of the organic solvent when the organic solvent volatilizes. The specific surface area of the twisted carbon nanotube wire will decrease, while the density and strength of the twisted carbon nanotube wire will increase.

The lead wire can be a conductive wire made of metal or metal alloy. The metal can be silver, copper, gold, aluminum, or a combination thereof.

In one embedment according to FIG. 3, each first conductive layer 142 is a lead wire made of one carbon nanotube wire structure. The carbon nanotube structure is an untwisted carbon nanotube wire.

The second conductive layer 162 includes a carbon nanotube layer structure. The carbon nanotube layer structure includes a plurality of carbon nanotubes joined by van der Waals attractive force therebetween. The carbon nanotube layer structure can be a substantially pure structure of carbon nanotubes, with few impurities. The carbon nanotube layer structure can be a freestanding structure, that is, the carbon nanotube layer structure can be supported by itself without a substrate. For example, if at least one point of the carbon nanotube layer structure is held, the entire carbon nanotube layer structure can be lifted without being destroyed.

The carbon nanotubes in the carbon nanotube layer structure can be orderly or disorderly arranged. The term ‘disordered carbon nanotube layer structure’ refers to a structure where the carbon nanotubes are arranged along different directions, and the aligning directions of the carbon nanotubes are random. The number of the carbon nanotubes arranged along each different direction can be almost the same (e.g. uniformly disordered). The disordered carbon nanotube layer structure can be isotropic, namely the carbon nanotube layer structure has properties identical in all directions of the carbon nanotube layer structure. The carbon nanotubes in the disordered carbon nanotube layer structure can be entangled with each other.

The carbon nanotube layer structure including ordered carbon nanotubes is an ordered carbon nanotube layer structure. The term ‘ordered carbon nanotube layer structure’ refers to a structure where the carbon nanotubes are arranged in a consistently systematic manner, e.g., the carbon nanotubes are arranged approximately along a same direction and/or have two or more sections within each of which the carbon nanotubes are arranged approximately along a same direction (different sections can have different directions). The carbon nanotubes in the carbon nanotube layer structure can be selected from single-walled, double-walled, and/or multi-walled carbon nanotubes. The carbon nanotube layer structure can include at least one carbon nanotube film.

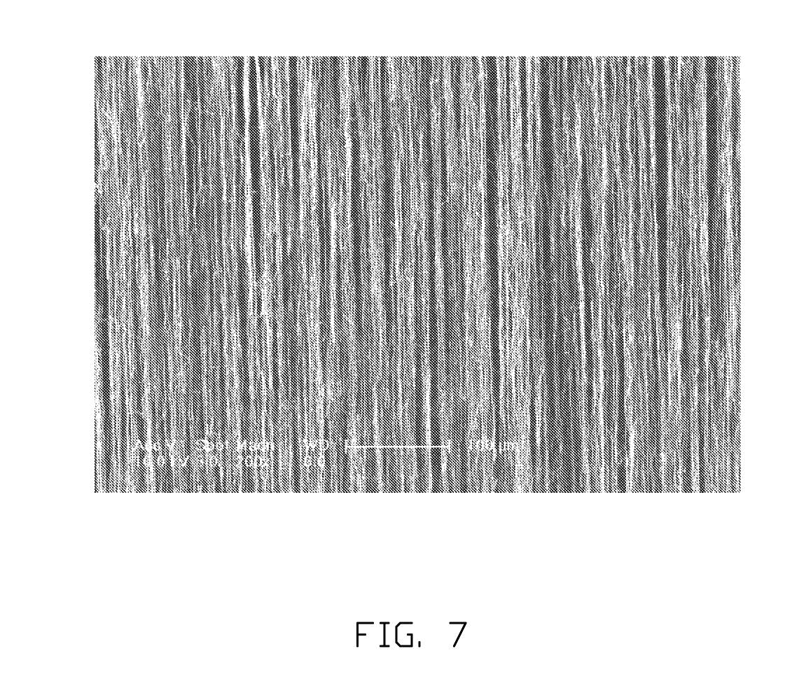

In one embodiment, the carbon nanotube film can be a drawn carbon nanotube film. Referring to FIG. 7, the drawn carbon nanotube film includes a number of successive and oriented carbon nanotubes joined end-to-end by van der Waals attractive force therebetween. The drawn carbon nanotube film is a free-standing film. Each drawn carbon nanotube film includes a number of successively oriented carbon nanotube segments joined end-to-end by van der Waals attractive force therebetween. Each carbon nanotube segment includes a number of carbon nanotubes substantially parallel to each other, and joined by van der Waals attractive force therebetween. Some variations can occur in the carbon nanotube film. The carbon nanotubes in the drawn carbon nanotube film are oriented along a preferred orientation. The drawn carbon nanotube film can be treated with an organic solvent to increase the mechanical strength and toughness of the drawn carbon nanotube film and reduce the coefficient of friction of the drawn carbon nanotube film. The thickness of the carbon nanotube film can range from about 0.5 nm to about 100 μm.

The carbon nanotubes in the drawn carbon nanotube structure can be single-walled, double-walled, and/or multi-walled carbon nanotubes. The diameters of the single-walled carbon nanotubes can range from about 0.5 nanometers to about 50 nanometers. The diameters of the double-walled carbon nanotubes can range from about 1 nanometer to about 50 nanometers. The diameters of the multi-walled carbon nanotubes can range from about 1.5 nanometers to about 50 nanometers. The lengths of the carbon nanotubes can range from about 200 μm to about 900 μm.

The carbon nanotube layer structure can include at least two stacked carbon nanotube films. The carbon nanotubes in the drawn carbon nanotube film are aligned along one preferred orientation, an angle can exist between the orientations of carbon nanotubes in adjacent drawn carbon nanotube films, whether stacked or adjacent. An angle between the aligned directions of the carbon nanotubes in two adjacent drawn carbon nanotube films can range from about 0 degrees to about 90 degrees, such as 15 degrees, 45 degrees or 60 degrees.

In other embodiments, the carbon nanotube film can be a flocculated carbon nanotube film. The flocculated carbon nanotube film can include a plurality of long, curved, disordered carbon nanotubes entangled with each other. Furthermore, the flocculated carbon nanotube film can be isotropic. The carbon nanotubes can be substantially uniformly dispersed in the carbon nanotube film. Adjacent carbon nanotubes are acted upon by van der Waals attractive force to obtain an entangled structure with micropores defined therein. Due to the carbon nanotubes in the carbon nanotube layer structure being entangled with each other, the carbon nanotube layer structure employing the flocculated carbon nanotube film has excellent durability, and can be fashioned into desired shapes with a low risk to the integrity of the carbon nanotube layer structure. The thickness of the flocculated carbon nanotube film can range from about 0.5 nm to about 1 mm.

In other embodiments, the carbon nanotube film can be a pressed carbon nanotube film. The carbon nanotubes in the pressed carbon nanotube film are arranged along a same direction or along different directions. The carbon nanotubes in the pressed carbon nanotube film can rest upon each other. Adjacent carbon nanotubes are attracted to each other and are joined by van der Waals attractive force. An angle between a primary alignment direction of the carbon nanotubes and a surface of the pressed carbon nanotube film is about 0 degrees to about 15 degrees. The greater the pressure applied, the smaller the angle obtained. If the carbon nanotubes in the pressed carbon nanotube film are arranged along different directions, the carbon nanotube layer structure can be isotropic. Here, “isotropic” means the carbon nanotube film has properties identical in all directions substantially parallel to a surface of the carbon nanotube film. The thickness of the pressed carbon nanotube film ranges from about 0.5 nm to about 1 mm.

In one embodiment, the second conductive layer 162 is a flocculated carbon nanotube film. A thickness of the second conductive layer 162 is about 10 micrometers.

In use of the keyboard 10, the keyboard 10 is connected to an electronic device via USB port or Bluetooth system. The first electrodes 144 and the third electrode 164 are the input electrodes configured to input voltage signals, and the second electrodes 146 are the output electrodes configured to output voltage signals. When one of the keys 102c is pressed down, the first conductive layer 142 contacts the second conductive layer 162, the location of the pressed key 120c can be detected by measuring a voltage of each second electrode 146. If a plurality of keys 102c is pressed, the second electrodes 146 can be used to detect the location of each touching point. The location of one pressed keys 102c at the Y direction can be detected by the corresponding second electrode 146. The location of the touching point at the X direction can be detected by the voltage change of the second electrode 146, because a change of the voltage of the second electrodes 146 is related to a distance between the pressed key 102c and the second electrode 146. As such, the location of each pressed key 102c can be detected. Because the first conductive layers 142 do not affect each other, the locations of the plurality of touching points can be detected at the same time.

The keyboard 10 disclosed in the present disclosure is a flexible keyboard, which increases the portability of the keyboard 10. When the keyboard 10 is connected with an electronic device, such as a mobile phone, the keyboard 10 can wrap around the mobile phone to protect the mobile phone. If the second substrate 108 of the keyboard 10 is made of fabric, the second substrate 108 can be used to clean the screen of the mobile phone.

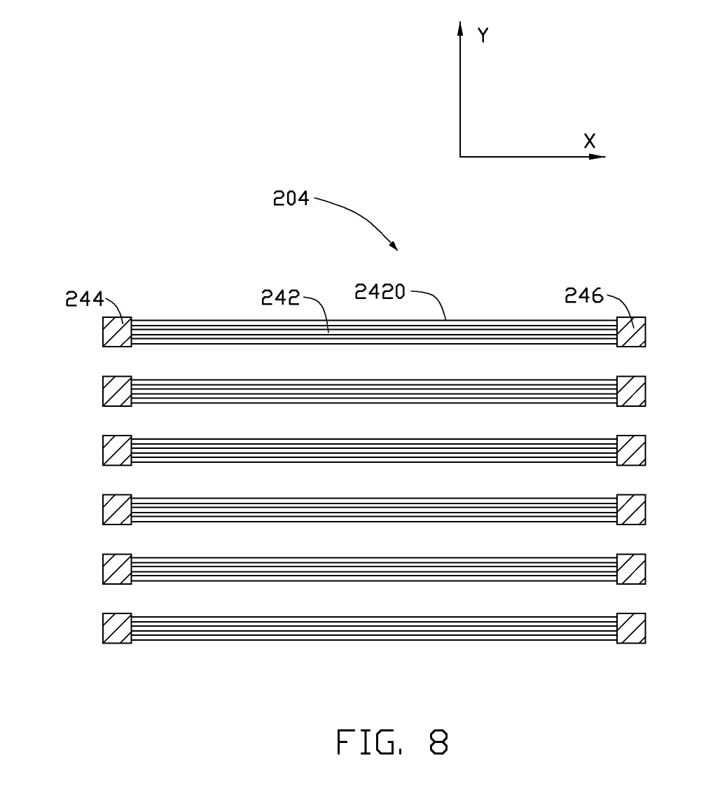

A keyboard according to another embodiment includes a first electrode layer 204 as shown in FIG. 8. The first electrode layer 204 includes a plurality of first conductive layers 242, a plurality of first electrodes 244 and a plurality of second electrodes 246. The first conductive layer 242 includes a plurality of lead wires 2420 located apart from each other. The plurality of lead wires 2420 in the first conductive layer 242 can be parallel with each other. Distance between adjacent lead wires 2420 can be uniform and less than 1 millimeter. The plurality of lead wires 2424 can be disposed side by side and contacts with each other. In one embodiment according to FIG. 8, each first conductive layer 242 includes three lead wires 2420 disposed apart from each other, parallel with each other, and a distance between adjacent lead wires 2420 is about 100 micrometers.

Other characteristics of the keyboard are the same as the keyboard 10 disclosed above.

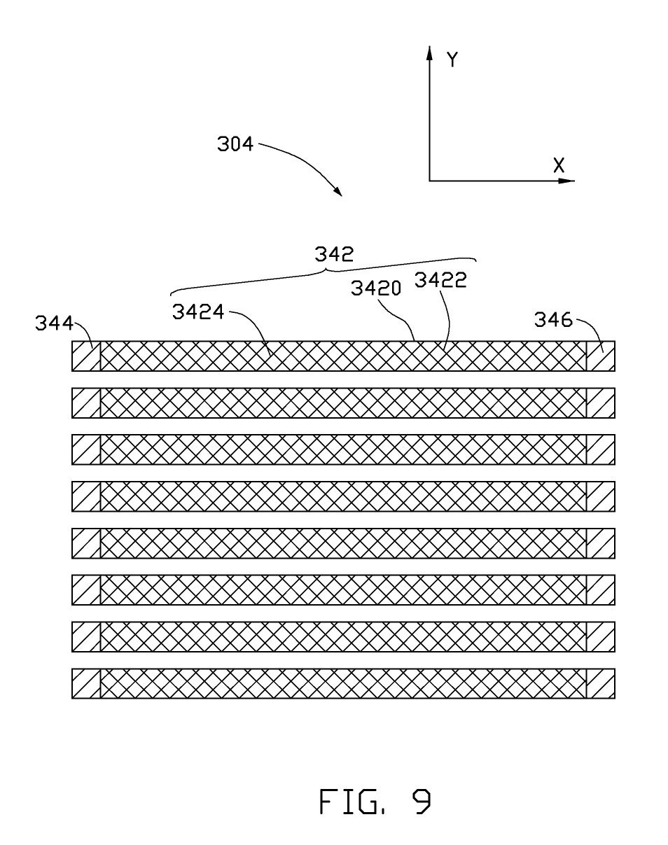

A keyboard according to another embodiment includes a first electrode layer 304 as shown in FIG. 9. The first electrode layer 304 includes a plurality of first Page 16 of 30 conductive layer 342, a plurality of first electrode 344, and a plurality of second electrode 346.

Each first conductive layer 342 includes a plurality of lead wires crossed with each other. In one embodiment according to FIG. 9, the plurality of lead wires in each first conductive layer 342 crosses each other to form a net structure. The net structure includes a plurality of pores defined by the lead wires. The net structure includes two edge wires 3420, a plurality of first lead wires 3422, and a plurality of second lead wires 3424. The two edge wires 3420 are located apart from each other and extend from one first electrode 344 to one second electrode 346. The plurality of first lead wires 3422 and the plurality of second lead wires 3424 are disposed between the two edge wires 3420. The first lead wires 3422 can be parallel with each other. The second lead wires 3424 can be parallel with each other. Distance between adjacent first lead wires 3422 can be in a range from 5 micrometers to about 2 millimeters. Distance between adjacent second lead wires 3422 can be in a range from 5 micrometers to about 2 millimeters.

Other characteristics of the keyboard are the same as the keyboard 10 disclosed above.

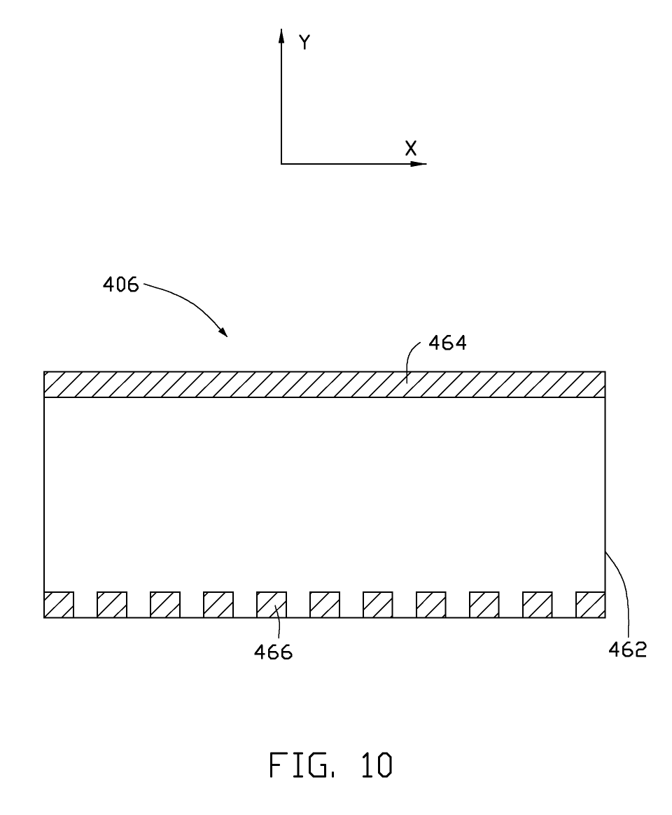

A keyboard according to another embodiment includes a first electrode layer (not shown) and a second electrode layer 406 having the structures as shown in FIG. 10.

The first electrode layer has the same structure as the first electrode layer 104 disclosed above.

The second electrode layer 406 includes a second conductive layer 462, a third electrode 464 and a plurality of fourth electrodes 466. The third electrode 464 is located at one end of and electrically connected with the second conductive layer 462. The plurality of fourth electrodes 466 is located at another end of and electrically connected with the second conductive layer 462. The third electrode 464 is oriented along an X direction. The plurality of fourth electrodes 466 is arranged along the X direction. A distance between adjacent fourth electrodes 466 can be uniform, and in a range from about 1 micrometer to about 1 centimeter. The second conductive layer 462 can be a conductive film having different resistances along different directions, e.g., the resistivity of the second conductive layer 462 in two-dimensional space is different. A resistivity of the second conductive layer 462 along the X direction is larger than the resistivity along the Y direction. The second conductive layer 462 can include an ordered carbon nanotube layer structure. The ordered carbon nanotube layer structure includes a plurality of carbon nanotubes oriented in a same direction. In one embodiment, the ordered carbon nanotube layer structure includes at least one drawn carbon nanotube film. The ordered carbon nanotube layer structure can include at least two drawn carbon nanotube films overlapped with each other. The carbon nanotubes in the at least two drawn carbon nanotube film are oriented in a same direction. In one embodiment according to FIG. 10, the carbon nanotubes in the carbon nanotube layer structure are oriented along the Y direction. A conductive passage is formed between each fourth electrode 466 and the third electrode 464, and a plurality of conductive passages is formed on the second electrode layer 406.

In use of the keyboard, low voltage is input into the keyboard via the plurality of first electrode and the plurality of second electrodes, high voltage is input via the third electrode 464, and the location along the X direction of a pressed key can be detected by the fourth electrodes 466, because the pressed key is correspond with one conductive passage defined by one fourth electrode. Then, low voltage is input into the keyboard via the third electrode 464 and the fourth electrodes 466, high voltage is input via the first electrodes, and the location along Y direction of the pressed key can be detected by the second electrodes. When a plurality of keys is pressed at the same time, because the conductive passages do not affect each other, the locations of the plurality of touching points can be detected at the same time.

Other characteristics of the keyboard are the same as the keyboard 10 disclosed above.

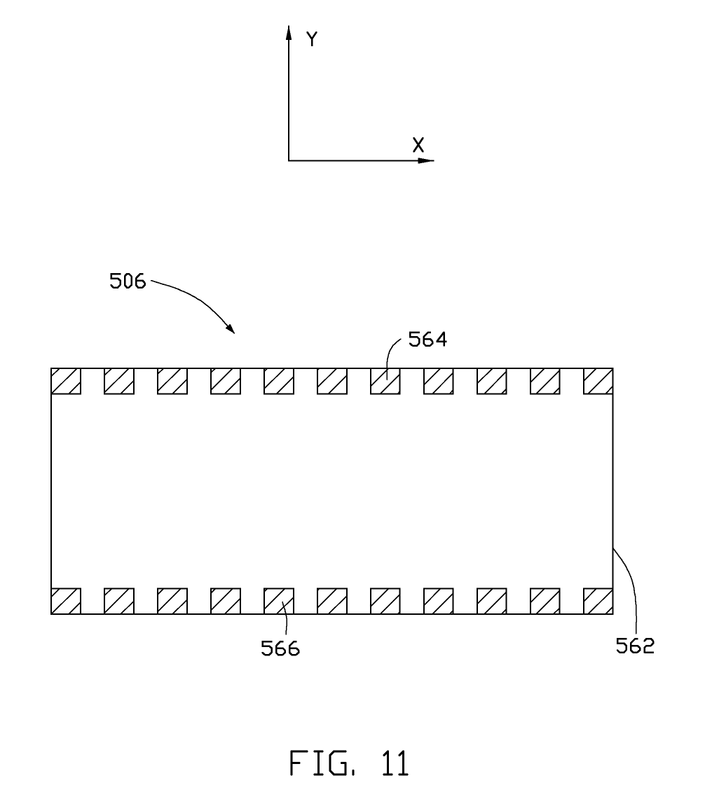

A keyboard according to another embodiment includes a first electrode layer (not shown) and a second electrode layer 506 having the structures as shown in FIG. 11.

The characteristics of the first electrode layer are the same as the first electrode layer 104 disclosed above.

The second electrode layer 506 includes a second conductive layer 562, a plurality of third electrodes 564 and a plurality of fourth electrodes 566. The plurality of third electrodes 564 is located at one end of and electrically connected with the second conductive layer 562. The plurality of fourth electrodes 566 is located at another end of and electrically connected with the second conductive layer 562. The plurality of third electrode 564 is oriented along X direction. A distance between adjacent third electrodes 564 can be uniform, and in a range from about 1 micrometer to about 1 centimeter. The fourth electrodes 566 are arranged along X direction. A distance between adjacent fourth electrodes 566 can be uniform, and in a range from about 1 micrometer to about 1 centimeter. The first conductive layer 562 can be a conductive film having different resistances along different directions, e.g., the resistivity of the first conductive layer 562 in two-dimensional space is different. The characters of the second conductive layer 562 are the same as the second conductive layer 462 disclosed above. A conductive passage is formed between each third electrode 566 and each fourth electrode 564, thereby a plurality of conductive passages is formed on the second electrode layer 506. The plurality of conductive passages on the second electrode layer 506 is substantially perpendicular to the conductive passages on the first electrode layer.

In use of the keyboard, the first electrodes and the second electrodes can be used as input electrodes alternatively. The third electrodes 564 and the fourth electrodes 566 can be used as output electrodes alternatively. In one embodiment, low voltage is input into the keyboard via the plurality of first electrodes and the second electrodes, high voltage is input via the third electrodes 564, the fourth electrodes 566 are used as output electrodes. The location along the X direction of a pressed key can be detected by the fourth electrodes 566. Then, low voltage is input into the keyboard via the third electrodes 564 or the fourth electrodes 366, high voltage is input via the first electrodes, the second electrodes are used as output electrodes. The location along Y direction of the pressed key can be detected by the second electrodes.

Other characteristics of the keyboard are the same as the keyboard 10 disclosed above.

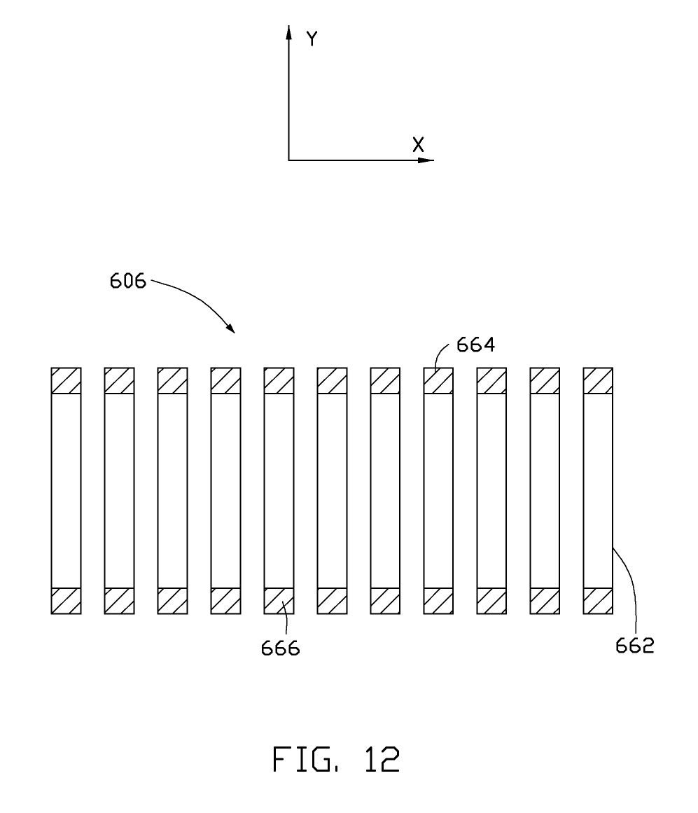

A keyboard according to another embodiment includes a first electrode layer (not shown) and a second electrode layer 606 having structures as shown in FIG. 12.

Characteristics of the first electrode layer are the same as the first electrode layer 104 as disclosed above.

The second electrode layer 606 includes a plurality of second conductive layers 662, a plurality of third electrodes 664 and a plurality of fourth electrodes 666. In one embodiment, the second conductive layers 662 are oriented along Y direction. The third electrodes 664 and the fourth electrodes 666 are arranged in X direction.

The plurality of second conductive layers 662 is bar-shaped and located apart from each other. Also, the second conductive layers 662 can be parallel with each other. A distance between adjacent conductive layers 662 can be uniform or random. The distance can be in a range from about 10 micrometers to about 1 centimeter. Each second conductive layer 662 includes the carbon nanotube layer structure disclosed above.

In use of the keyboard, the first electrodes and the second electrodes can be used as input electrodes alternatively. The third electrodes 664 and the fourth electrodes 666 can be used as output electrodes alternatively. In one embodiment, low voltage is input into the keyboard via the plurality of first electrodes and the second electrodes, high voltage is input via the third electrodes 664, the fourth electrodes 666 are used as output electrodes. The location along the X direction of a pressed key can be detected by the fourth electrodes 666. Then, low voltage is input into the keyboard via the third electrodes 664 or the fourth electrodes 666, high voltage is input via the first electrodes, the second electrodes are used as output electrodes. The location along Y direction of the pressed key can be detected by the second electrodes.

Other characteristics of the keyboard are the same as the keyboard 10 disclosed above.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

What is claimed is:

1. A keyboard comprising:
a first substrate comprising a first upper surface and a first lower surface opposite the first upper surface;
a second substrate located apart from the first substrate and comprising a second upper surface and a second lower surface opposite the second upper surface, the second upper surface facing the first lower surface;
a first electrode layer positioned on the first lower surface and comprising a plurality of first conductive layers positioned apart from each other, each of the plurality of first conductive layers comprising at least one lead wire;
a second electrode layer positioned on the second upper surface and comprising at least one second conductive layer comprising a carbon nanotube layer structure; and
a plurality of keys located on the first upper surface or the second lower surface.

2. The keyboard of claim 1, wherein the first electrode layer further comprises a plurality of first electrodes and a plurality of second electrodes, one of the plurality of first electrodes and one of the plurality of second electrodes are positioned on two opposite ends of and electrically connected with one of the plurality of first conductive layers.

3. The keyboard of claim 1, wherein the plurality of first conductive layers is parallel with each other and oriented in a first direction.

4. The keyboard of claim 1, wherein each of the first conductive layers is one lead wire oriented in a same direction.

5. The keyboard of claim 1, wherein each of the first conductive layers comprises a plurality of lead wires parallel with each other.

6. The keyboard of claim 1, wherein each of the first conductive layer comprises a plurality of lead wires crossed with each other to form a net structure.

7. The keyboard of claim 6, wherein the net structure comprises two edge wires, a plurality of first lead wires, and a plurality of second lead wires, the two edge wires are parallel and positioned apart from each other, and the plurality of first lead wires and the plurality of second lead wires cross with each other and are positioned between the two edge wires.

8. The keyboard of claim 1, wherein the at least one lead wire comprises a carbon nanotube wire structure comprising a plurality of carbon nanotubes joined end to end by van der Waals attractive force.

9. The keyboard of claim 8, wherein the carbon nanotube wire structure comprises at least one untwisted carbon nanotube wire comprising a plurality of carbon nanotubes oriented along an axial direction of the at least one untwisted carbon nanotube wire.

10. The keyboard of claim 8, wherein the carbon nanotube wire structure comprises at least one twisted carbon nanotube wire comprising a plurality of carbon nanotubes oriented around an axial direction of the at least one untwisted carbon nanotube wire.

11. The keyboard of claim 1, wherein the plurality of first conductive layers is oriented along a first direction, the second electrode layer further comprises a third electrode positioned on one end of the at least one second conductive layer and oriented along the first direction, and a plurality of fourth electrodes positioned on another end of the at least one second conductive layer and arranged along the first direction, and the carbon nanotube layer structure comprises a plurality of carbon nanotubes oriented along a second direction perpendicular with the first direction.

12. The keyboard of claim 1, wherein the plurality of first conductive layers is oriented along a first direction, the second electrode layer further comprises a plurality of third electrodes positioned on one end of the at least one second conductive layer and arranged in the first direction, and a plurality of fourth electrodes positioned on another end of the at least one second conductive layer and arranged in the first direction, and the carbon nanotube layer structure comprises a plurality of carbon nanotubes oriented along a second direction perpendicular with the first direction.

13. The keyboard of claim 1, wherein the second electrode layer comprises a plurality of second conductive layers positioned apart from each other and oriented in a same direction.

14. The keyboard of claim 1, wherein the second electrode layer comprises a third electrode positioned on a surface of the second conductive layer and symmetrically aligned with four sides of the second conductive layer.

15. The keyboard of claim 1, wherein each of the plurality of first conductive layers is positioned between one first electrode and one second electrode and defines one conductive passage, and a plurality of conductive passages are defined.

16. The keyboard of claim 15, wherein the plurality of keys is arranged in a plurality of rows, the number of the plurality of passages is larger or equal to the number of the plurality of rows.

17. The keyboard of claim 1, wherein materials of the first substrate and the second substrate are flexible, the plurality of keys is positioned on the first upper surface of the first substrate, and a material of the second substrate is fabric.

18. A keyboard comprising:
a first substrate;
a second substrate positioned apart from the first substrate;
a first electrode layer positioned on a surface of the first substrate comprising a plurality of first conductive layers positioned apart from each other, each of the plurality of first conductive layers comprises at least one carbon nanotube wire structure comprising a plurality of carbon nanotubes joined end to end;
a second electrode layer positioned on a surface of the second substrate and facing the first electrode layer, the second electrode layer comprising at least one second conductive layer comprising a carbon nanotube layer structure comprising a plurality of carbon nanotubes dispersed randomly and uniformly.

19. The keyboard of claim 18, wherein the first substrate comprises a plurality of keys arranged in a plurality of rows, the number of the plurality of first conductive layers is equal to or large than the plurality of rows.

20. The keyboard of claim 19, wherein the plurality of keys and the plurality of conductive layers are arranged in one by one manner.
